(19) United States
(12) Patent Application Publication
(10) Pub. No.: US 2013/0028833 A1
(43) Pub. Date: Jan. 31, 2013

(54) METHOD FOR PREPARING A HYDROLYZATE

(71) Applicants: Aharon Eyal, Jerusalem (IL); Asher Vitner, Jerusalem (IL); Revital Mali, Jerusalem (IL)

(72) Inventors: Aharon Eyal, Jerusalem (IL); Asher Vitner, Jerusalem (IL); Revital Mali, Jerusalem (IL)

(73) Assignee: HCL CLEANTECH LTD., Herzelia (IL)

(21) Appl. No.: 13/577,215

(22) PCT Filed: Feb. 6, 2011
(86) PCT No.: PCT/IL2011/000131

§ 371 Date: Oct. 16, 2012

Related U.S. Application Data
(60) Provisional application No. 61/302,114, filed on Feb. 6, 2010.

(30) Foreign Application Priority Data
Feb. 1, 2011 (IL) 210,999

(51) Int. Cl. C01B 7/01; C09K 3/00

(52) U.S. Cl. 423/488; 252/182.32; 252/182.12

(57) ABSTRACT

The present invention provides an organic phase composition comprising
(f) a first solvent (S1) characterized by water solubility of less than 10% and by at least one of (a1) having a polarity related component of Hoy's cohesion parameter (delta-P) between 5 and 10 mPa^{1/2} and (b1) having a Hydrogen bonding related component of Hoy's cohesion parameter (delta-H) between 5 and 20 MPa^{1/2};
(g) a second solvent (S2) characterized by water solubility of at least 30% and by at least one of (a2) having a delta-P greater than 8 MPa^{1/2} and (b2) having a delta-H greater than 12 MPa^{1/2};
(h) water
(i) HCl, and
(j) a chloride salt.

The present invention relates to a novel method for the separation of HCl from a chloride salt and to an organic phase composition produced thereby

The carbohydrates-conversion industry is large and increases rapidly. Thus, nearly 100 million tons of carbohydrates are fermented annually to fuel-grade ethanol and this number is expected to triple in the next decade. Millions of tons of carbohydrates are also fermented every year into food and feed products, such as citric acid and lysine. Fermentation to industrial products is also increasing, such as the production of monomers for the polymer industry, e.g. lactic acid for the production of polylactide. Carbohydrates are an attractive and environmental-friendly substrate since they are obtained from renewable resources, such as sucrose from sugar canes and glucose from corn and wheat starches. Such renewable resources are limited in volume and increased consumption is predicted to increase food costs. There is therefore a strong motivation to generate carbohydrates from renewable non-food resources. It is particularly desired to produce such carbohydrates at costs that are lower than those of the food carbohydrates. Low cost carbohydrates will open the way for much greater production of biofuels and industrial products, such as monomers. Thus, new processes are being developed for the production of alternative fuels such as fatty acid esters and hydrocarbons which can be directly formed by fermentation or produced by conversion of fermentation products. The majority of the future production from carbohydrates will use fermentation, but chemical conversion of carbohydrates also seems attractive.

An abundant and relatively-low cost source of carbohydrates is woody material, such as wood and co-products of wood processing and residues of processing agricultural products, e.g. corn stover and cobs, sugar cane bagasse and empty fruit bunches from palm oil production. There is also the potential of growing switch grass and other “energy crops” that generate low-cost rapid growing biomass for that purpose. Such carbohydrate sources contain as their main components cellulose, hemicellulose and lignin and are also referred to as lignocellulosic material. Such material also contains mineral salts (ashes) and organic compounds, such as tall oils. Cellulose and hemicellulose, which together form 65-80% of the lignocellulosic material, are polysaccharides and their hydrolysis forms carbohydrates suitable for fermentation and chemical conversion to products of interest. Hydrolysis of hemicellulose is relatively easy, but that of cellulose, which typically forms more than one half of the polysaccharides content, is difficult due to its crystalline structure. Presently known methods for converting lignocellulosic material to carbohydrates involve enzymatic-catalyzed and/or acid-catalyzed hydrolysis. In many cases, pre-treatments are involved, e.g. lignin and/or hemicellulose extraction, steam or ammonia explosion, etc. The known technologies are still too expensive and there is a strong need for alternative, lower-cost ones. In addition, carbohydrates cost could be lowered by valorizing co-products such as lignin and tall oils. There is therefore a need for technology that, in addition to using low-cost hydrolysis, generates those co-products at high quality.

Acid hydrolysis of lignocellulosic material was considered and tested as a pre-treatment for enzymatic hydrolysis. Alternatively, acid could be used as the sole hydrolysis catalyst, obviating the need for high-cost enzymes. Most of the efforts focused on sulfuric acid and hydrochloric acid (HCl), with preference for the latter. In fact, HCl-based hydrolysis of lignocellulosic material, using no enzymes, was implemented on an Industrial scale. Such hydrolysis forms a hydrolyzate stream containing the carbohydrate products, other soluble components of the lignocellulosic material and HCl. Since the lignin fraction of the material does not hydrolyze and stays essentially insoluble, the process also forms a co-product stream containing the lignin dispersed in or wetted by an aqueous solution of HCl.

Since HCl acts as a catalyst, it is not consumed in the process. It should be separated from the hydrolysis products and co-products and recycled for re-use. Such separation and recycle presents many challenges, some of which are listed in the following. Thus, the recovery yield needs to be high in order to minimize costs related to acid losses, to consumption of a neutralizing base and to disposal of the formed salt. In addition, residual acid content of the product and the co-products should be low in order to enable their optimal use. Acid recovery from the hydrolyzate should be conducted in conditions i.e., mainly temperature, minimizing thermal and HCl-catalyzed carbohydrate degradation. Recovery of HCl from a lignin co-product stream is complicated by the need to deal with solids and by the need to form HCl-free lignin. The literature suggests washing HCl off the lignin, but the amount of water required is large, the wash solution is therefore dilute and recycle to hydrolysis requires re-concentration at high cost. Another major challenge is related to the concentration of the separated and recovered acid. For high yield hydrolysis of the cellulosic fraction of the lignocellulosic material, concentrated HCl is required, typically greater than 40%. Thus, the recovered acid is preferably obtained at that high concentration in order to minimize re-concentration costs.

Still another challenge is related to the fact that HCl forms an azeotrope with water. Since HCl is volatile, recovery from HCl solutions by distillation is attractive in generating a gaseous, nearly dry HCl stream. Yet, due to the formation of the azeotrope, such distillation is limited to removing HCl down to azeotropic concentration, which is about 20%, depending on the conditions. Further removal of HCl requires co-distillation with water to form a vapor phase wherein HCl concentration is about 20%. Therefore, in order to achieve complete removal of the acid from the carbohydrate, distillation to dryness would be required. Alternatively, addition of water, or steam stripping, dilutes the residual acid to below the azeotropic concentration. As a result, mainly water evaporates, i.e. the residual HCl is obtained in a highly dilute HCl stream, which then entails high re-concentration costs. Furthermore, studies of such removal have concluded that steam stripping cannot achieve full removal of the acid. K. Schoenemann in his presentation entitled “The New Rheinau Wood Saccharification Process” to the Congress of Food and Agricultural Organization of The United. Nations at Stockholm in July 1953 reviewed the concentrated HCl-based processes and the related physical properties data. His conclusion was: “as the boiling line . . . demonstrates, it is not possible to distill the hydrogen chloride completely from the sugar solution by a simple distillation, not even by spray-distillation, as it was attempted formerly. Thus, the hydrochloric acid could be removed in a post-evaporation down to 3.5%, calculated on sugars, by injecting steam, which acts like alternating diluting and distilling.” Such amount of residual HCl in the carbohydrates is industrially unacceptable.

In addition, HCl removal from highly concentrated carbohydrate solutions is complicated by the high viscosity of the formed streams. Some efforts were made in the past to remove the residual acid by spray drying the hydrolyzate. Based on various studies, spray drying cannot achieve complete removal of the acid. Such incomplete removal of the acid decreases recovery yield and requires neutralization in the product or indirectly on an ion-exchanger. In addition, since the feed to the spray drier should be fluid, the amount of water and HCl removed by distillation from the hydrolyzate is limited According to F. Bergius, the developer of the HCl-hydrolysis technology, in his publication “Conversion of wood to carbohydrates and problems in the industrial use of concentrated hydrochloric acid” published in Industrial and Engineering Chemistry (1937), 29, 247-53, 80% of the HCl can be removed by evaporation prior to spray drying. Thus, large amounts of water and HCl should be removed in the spray drier, which increases both the capital and the operating cost of such a process.

In latter developed technologies, a fraction of the acid in the hydrolyzate is distilled out as a gaseous, nearly dry HCl, to reach azeotropic concentration. Optionally, another fraction of the acid is distilled as gas of azeotropic composition. Then, the residual acid is removed by alternative, non-distillative means, such as crystallization, membrane separation and solvent extraction by various solvents. The assignee of the present invention has several patent applications in which an acid-base couple extractant is used for that purpose. Solvent extraction was found to fully remove the residual acid, but at a relatively high equipment cost and with the need for special operations to avoid extractant losses and product contamination by the extractant.

### SUMMARY OF THE INVENTION

The present invention provides, according to a first aspect, an organic phase composition comprising: (a) a first solvent (S1) characterized by a water solubility of less than 10% and by at least one of (a1) having a polarity related component of Hoy's cohesion parameter (delta-P) between 5 and 10 MPa^{1/2} and (b1) having a hydrogen bonding related component of Hoy's cohesion parameter (delta-H) between 5 and 20 MPa^{1/2}; (b) a second solvent (S2) characterized by a water solubility of at least 30% and by at least one of (a2) having a delta-P greater than 8 MPa^{1/2} and (b2) having a delta-H greater than 12 MPa^{1/2}; (c) water, (d) HCl, and (e) a chloride salt.

According to various embodiments, S2 is selected from the group consisting of C₁-C₄ mono- and/or poly-alcohols, aldehydes and ketones and S1 is selected from the group consisting of alcohols, ketones and aldehydes having at least 5 carbon atoms.

According to an embodiment, said chloride salt is selected from the group consisting of chlorides of calcium and of heavy metals.

According to various embodiments, the weight/weight ratio of S1/S2 is in the range of between 10 and 0.5; the weight/weight ratio of HCl/water is greater than 0.15, the weight/weight ratio of HCl/chloride salt is greater than 5 and/or the chloride salt concentration is in a range of between 0.01% wt and 5% wt.

According to other embodiments, S1 forms a heterogeneous azeotrope with water and/or S2 forms a homogeneous azeotrope with water.

The present invention provides, according to still another embodiment, an organic phase composition consisting essentially of: (a) a first solvent (S1) characterized by a water solubility of less than 10% and by at least one of (a1) having a polarity related component of Hoy's cohesion parameter (delta-P) between 5 and 10 MPa^{1/2} and (b1) having a hydrogen bonding related component of Hoy's cohesion parameter (delta-H) between 5 and 20 MPa^{1/2}; (b) a second solvent (S2) characterized by a water solubility of at least 30% and by at least one of (a2) having a delta-P greater than 8 MPa^{1/2} and (b2) having a delta-H greater than 12 MPa^{1/2}; (c) water, (d) HCl, and (e) a chloride salt.

The present invention provides, according to a second aspect, a method for the separation of HCl from a chloride salt comprising: (i) providing an aqueous feed solution comprising HCl and a chloride salt; (ii) bringing said aqueous feed solution into contact with a first extractant comprising a first solvent (S1) characterized by a water solubility of less than 10% and by at least one of (a1) having a delta-P between 5 and 10 MPa^{1/2} and (b1) having a delta-H between 5 and 20 MPa^{1/2}, whereupon HCl selectively transfers to said first extractant to form an HCl-carrying first extract and an HCl-depleted aqueous feed; (iii) bringing said HCl-depleted aqueous feed solution into contact with a second extractant comprising S1 and a second solvent (S2) characterized by a water solubility of at least 30% and by at least one of (a2) having a delta-P greater than 8 MPa^{1/2} and (b2) having a delta-H greater than 12 MPa^{1/2}, whereupon HCl selectively transfers to said second extractant to form an organic phase composition according to the first aspect and a further HCl-depleted aqueous feed; and (iv) recovering HCl from said first extract.

According to an embodiment, said aqueous feed is a product of leaching a mineral with HCl. According to another embodiment, said mineral is rich in titanium.

According to an embodiment, at least one of said bringing in contact of step (ii) and said bringing in contact of step (iii) comprises multiple stage counter-current contacting.

According to an embodiment, the delta-P of said second extractant is greater than the delta-P of said first extractant by at least 0.2 MPa^{1/2}. According to another embodiment, the delta-H of said second extractant is greater than the delta-H of said second extractant by at least 0.2 MPa^{1/2}.

According to an embodiment the first extractant comprises S2 and the S2/S1 ratio in the second extractant is greater than the S2/S1 ratio in the first extractant by at least 10%. According to a related embodiment, the first extractant is generated from the organic phase composition formed in step (iii) by removing S2 therefrom.

According to an embodiment, the method comprises a step of removing S2 from the organic phase composition formed in step (iii), whereupon said first extract is formed. According to a related embodiment, upon removing S2, a heavy aqueous phase is formed and said heavy phase is separated from said formed first extract. According to related embodiments, the HCl/water ratio in heavy phase is smaller than that ratio in the HCl-depleted aqueous feed and/or the HCl/chloride salt ratio in the heavy phase is smaller than that ratio in the HCl-depleted aqueous feed.

According to various embodiments, the HCl/water ratio in the first extract is greater than that ratio in the organic phase composition of step (iii) by at least 10%; the HCl/water ratio in the first extract is greater than that ratio in the aqueous feed by at least 10% and/or the HCl/chloride salt ratio in said first extract is greater than that ratio in the organic phase composition of step (iii) by at least 10%.

According to an embodiment, recovering comprises at least one of HCl distillation and back-extraction with water or with an aqueous solution.

According to another embodiment, the HCl/chloride salt ratio in the further depleted aqueous feed is smaller than 0.05.

According to still another embodiment, the provided aqueous feed comprises an impurity, the impurity/chloride salt ratio in said feed is R1, the impurity/chloride salt ratio in the further depleted aqueous feed is R2 and the R1/R2 ratio is greater than 1.5. According to an embodiment, said impurity is another acid. According to another embodiment, said impurity is another salt.

### BRIEF DESCRIPTION OF THE DRAWINGS

The present invention will be understood and appreciated more fully from the following detailed description taken in conjunction with the appended drawing in which:

FIG. 1 shows a schematic description of one embodiment of the process of the present invention.

In some embodiments, the term “consisting essentially of refers to a composition whose only active ingredients are the indicated active ingredients, however, other compounds may be included which are involved directly in the technical effect of the indicated active ingredients. In some embodiments, the term “consisting essentially of” refers to a composition whose only active ingredients acting in a particular pathway, are the indicated active ingredients, however, other compounds may be included which are involved in the indicated process, which for example have a mechanism of action related to but not directly to that of the indicated agents. In some embodiments, the term “consisting essentially of refers to a composition whose only active ingredients are the indicated active ingredients, however, other compounds may be included which are for stabilizing, preserving, etc. the composition, but are not involved directly in the technical effect of the indicated active ingredients. In some embodiments, the term “consisting essentially of” may refer to components which facilitate the release of the active ingredients. In some embodiments, the term “consisting essentially of refers to a composition, which contains the active ingredients and other acceptable solvents, which do not in any way impact the technical effect of the indicated active ingredients.

The present invention provides, according to an aspect, an organic phase composition consisting essentially of: (a) a first solvent (S1) characterized by a water solubility of less than 10% and by at least one of (a1) having a polarity related component of Hoy's cohesion parameter (delta-P) between 5 and 10 MPa^{1/2} and (b1) having a hydrogen bonding related component of Hoy's cohesion parameter (delta-H) between 5 and 20 MPa^{1/2}; (b) a second solvent (S2), characterized by a water solubility of at least 30% and by at least one of (a2) having a delta-P greater than 8 MPa^{1/2} and (b2) having a delta-H greater than 12 MPa^{1/2}; (c) water, (d) HCl, and (e) a chloride salt.

The present invention provides, according to an aspect, a method for the separation of HCl from a chloride salt comprising: (i) providing an aqueous feed solution comprising HCl and the chloride salt; (ii) bringing said aqueous feed solution into contact with a first extractant comprising a first solvent (S1) characterized by a water solubility of less than 10% and by at least one of (a1)) having a delta-P between 5 and 10 MPa^{1/2} and (b1) having a delta-H between 5 and 20 MPa^{1/2}, whereupon HCl selectively transfers to said first extractant to form an HCl-carrying first extract and an HCl-depleted aqueous feed; (iii) bringing said HCl-depleted aqueous feed solution into contact with a second extractant comprising S1 and a second solvent (S2) characterized by a water solubility of at least 30% and by at least one of (a2) having a delta-P greater than 8 MPa^{1/2} and (b2) having a delta-H greater than 12 MPa^{1/2}, whereupon HCl selectively transfers to said second extractant to form an organic phase composition according to the first aspect and a further HCl-depleted aqueous feed; and (iv) recovering HCl from said first extract, wherein delta-P is the polarity related component of Hoy's cohesion parameter and delta-H is the hydrogen bonding related component of Hoy's cohesion parameter.

The feed to the process is an aqueous solution comprising HCl and a chloride salt. According to an embodiment, said aqueous feed is a product of leaching a mineral with HCl. According to another embodiment, said mineral is rich in titanium. Preferably, leaching is in a highly concentrated HCl solution, forming an aqueous solution leachate containing HCl and chloride salts and optionally an insoluble fraction. Such insoluble fraction is separated and the leachate is used as such, or after some modification. According to an embodiment, modification may include distilling out some of the HCl. According to an embodiment, the chloride salt is selected from the group consisting of chloride salts of calcium and of heavy metals. According to a preferred embodiment, said heavy metal is titanium. Unless specified otherwise, the term “salt” as used herein means chloride salt.

According to the method of the invention, the feed is brought into contact with a first extractant comprising a first solvent (S1). The solubility of S1 in water at 25° C. is less than 10%, preferably less than 5%, more preferably less than 2% and most preferably less than 1%. S1 is further characterized by at least one of (a1) having a delta-P between 5 and 10 MPa^{1/2}, preferably between 6 and 9 MPa^{1/2} and more preferably between 6.5 and 8.5 MPa^{1/2} and (b1) having a delta-H between 5 and 20 MPa^{1/2}, preferably between 6 and 16 MPa^{1/2} and more preferably between 8 and 14 MPa^{1/2}, wherein delta-P is the polarity related component of Hoy's cohesion parameter and delta-H is the hydrogen bonding related component of Hoy's cohesion parameter. According to an embodiment, the boiling point of S1 is greater than that of water, preferably greater than 120° C. at atmospheric pressure, more preferably greater than 140° C., and most preferably greater than 160° C.

According to another embodiment, the boiling point of S1 is lower than 250° C. at atmospheric pressure, more preferably lower than 220° C., and most preferably lower than 200° C. According to another embodiment, S1 forms a heterogeneous azeotrope with water. According to an embodiment, the boiling point of that heterogeneous azeotrope is less than 100° C. at atmospheric pressure.

According to an embodiment, S1 forms at least 60% of the first extractant, preferably at least 80% and more preferably at least 90%. According to a preferred embodiment S1 is the sole solvent in the first extractant. According to an embodiment, the first extractant also comprises water.

The cohesion parameter,as referred to above, or, solubility parameter, was defined by Hildebrand as the square root of the cohesive energy density:

$$δ = \sqrt{\frac{Δ {E}_{vap}}{V}}$$

wherein ΔEvap and V are the energy or heat of vaporization and molar volume of the liquid, respectively. Hansen extended the original Hildebrand parameter to three-dimensional cohesion parameter. According to this concept, the total solubility parameter, delta, is separated into three different components, or, partial solubility parameters relating to the specific intermolecular interactions:

δ²=δ_{d}²+δₚ²+δₕ²

wherein δ_{d}, δₚ and δₕ are the dispersion, polarity, and hydrogen bonding components, respectively. Hoy proposed a system to estimate total and partial solubility parameters. The unit used for those parameters is MPa^{1/2}. A detailed explanation of that parameter and its components could be found in “CRC Handbook of Solubility Parameters and Other Cohesion Parameters”, second edition, pages 122-138. That and other references provide tables with the parameters for many compounds. In addition, methods for calculating such parameters are provided.

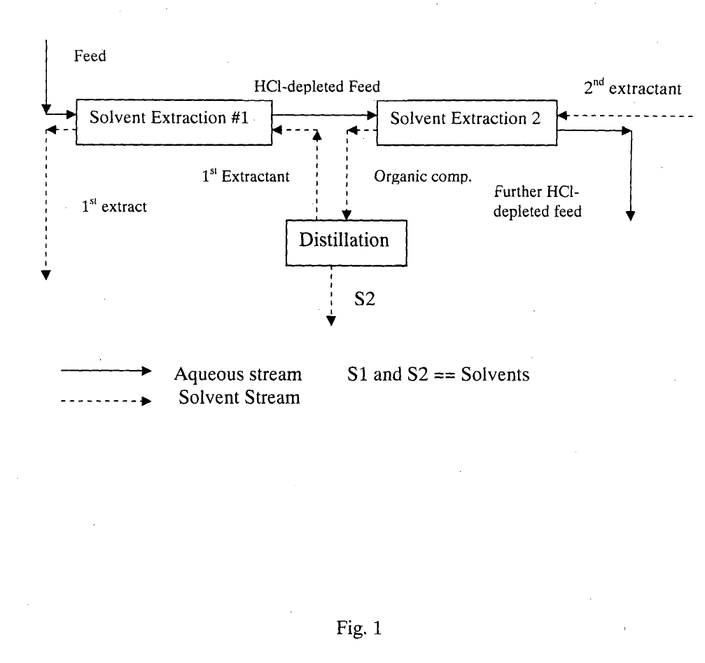

In FIG. 1, the aqueous feed (Feed in FIG. 1) and the first extractant (1^{st} Extractant in FIG. 1) are brought in contact in the operation marked Solvent Extraction #1. According to an embodiment, contacting consists of a multiple-stage counter-current operation conducted in commercial liquid-liquid contactors, e.g. mixers-settlers or pulsating columns.

Contacting results in selective transfer of HCl from the feed to the first extractant to form the HCl-carrying first extract and the HCl-depleted aqueous feed, which are then separated. The term selective transfer of HCl, as used herein, means that, on a solvent-free basis, HCl concentration in the first extract is greater than HCl concentration on the feed. According to an embodiment, the chloride salt also transfers from the feed to the first extractant, but the HCl/chloride salt ratio in the first extract is greater than that ratio in the aqueous feed by at least 2 times, preferably by at least 5 times and more preferably by at least 10 times. According to another embodiment, water also transfers from the feed to the first extractant, but the HCl/water ratio in the first extract is greater than that ratio in the aqueous feed by at least 10%, preferably by at least 30%, more preferably by at least 60% and most preferably by at least 100%.

According to the method of the invention the separated HCl-depleted aqueous feed solution is brought into contact with a second extractant comprising S1, which is the same solvent as in the first extractant and a second solvent (S2). The solubility of S1 in water at 25° C. is greater than 30%, preferably greater than 50%, more preferably greater than 60% and most preferably S2 is fully miscible with water. S2 is further characterized by at least one of (a2) having a delta-P greater than 8 MPa^{1/2}, preferably greater than 10 MPa^{1/2} and more preferably greater than 12 MPa^{1/2} and (b1) having a delta-H greater than 12 MPa^{1/2}, preferably greater than 14 MPa^{1/2} and more preferably greater than 16 MPa^{1/2}. According to an embodiment, the boiling point of S2 is lower than that of water, preferably lower than 90° C. at atmospheric pressure, more preferably lower than 80° C., and most preferably lower than 75° C. According to another embodiment the boiling point of S2 is greater than 20° C. at atmospheric pressure. According to another embodiment, S2 forms a homogeneous azeotrope with water.

According to an embodiment, a mixture of S1 and S2 forms at least 60% of the second extractant, preferably at least 80% and more preferably at least 90%. According to a preferred embodiment S1 and S2 are the only solvents in the second extractant. According to an embodiment, the second extractant also comprises water. According to an embodiment, the method further comprises the step of forming the second extractant and said forming comprises combining the first solvent formed in said recovering of the acid in step (iv) with S2.

In FIG. 1, the HCl-depleted aqueous feed and the second extractant are brought in contact in the operation marked Solvent Extraction #2. According to an embodiment, contacting consists of a multiple-stage counter-current operation conducted in commercial liquid-liquid contactors, e.g. mixers-settlers or pulsating columns. Upon contacting, HCl transfers selectively to the second extractant to form an organic phase composition and a further HCl-depleted aqueous feed, which according to an embodiment are separated. Thus, on a solvent free basis, HCl concentration in the organic phase composition is greater than HCl concentration in the HCl-depleted aqueous feed.

The formed, further HCl-depleted, aqueous feed is a de-acidified chloride salt solution suitable for use as such or after further treatment, e.g. further purification, electrowinning, hydrolysis, etc. According to an embodiment, the HCl/chloride salt ratio in that further HCl-depleted aqueous feed is less than 0.05, preferably less than 0.03, more preferably less than 0.02 and most preferably less than 0.01.

According to an embodiment of the present invention, the organic phase composition comprises: (a) a first solvent (S1) characterized by a water solubility of less than 10% and by at least one of (a1) having a polarity related component of Hoy's cohesion parameter (delta-P) between 5 and 10 MPa^{1/2} and (b1) having a hydrogen bonding related component of Hoy's cohesion parameter (delta-H) between 5 and 20 MPa^{1/2}; (b) a second solvent (S2) characterized by a water solubility of at least 30% and by at least one of (a2) having a delta-P greater than 8 MPa^{1/2} and (b2) having a delta-H greater than 12 MPa^{1/2}; (c) water, (d) HCl, and (e) a chloride salt.

According to various embodiments, S2 is selected from the group consisting of C1-C4 mono- and/or poly-alcohols, aldehydes and ketones and S1 is selected from the group consisting of alcohols, ketones and aldehydes having at least 5 carbon atoms.

According to an embodiment, said chloride salt is selected from the group consisting of chlorides of calcium and of heavy metals. According to an embodiment, the chloride salt is titanium chloride.

According to an embodiment, the organic phase composition is formed as a result of said contacting of the HCl-depleted aqueous feed with the second extractant, the first solvent (S1) is the first solvent of the first and second extractant, the second solvent (S2) is the second solvent of the second extractant and the HCl, the water and the chloride salt are extracted from the HCl-depleted aqueous feed.

According to an embodiment S1 is selected from the group consisting of alcohols, ketones and aldehydes having at least 5 carbon atoms, e.g., various pentanols, hexanols, heptanols, octanols, nonanols, decanols, methyl-isobutyl-ketone, methyl-butyl-ketone and the like.

According to an embodiment, S2 is selected from the group consisting of C1-C4 mono- and/or poly-alcohols, aldehydes and ketones, e.g. methanol, ethanol, propanol, iso-propanol, n-butanol, tert-butanol, ethylene glycol, acetone and the like.

According to various embodiments, the weight/weight ratio of S1/S2 within the organic phase composition is in the range between 10 and 0.5, preferably between 1 and 9 and more preferably between 2 and 8.

According to another embodiment, the weight/weight ratio of HCl/water in the organic phase composition is greater than 0.15, preferably greater than 0.20 and more preferably greater than 0.25.

According to another embodiment the weight/weight ratio of HCl/chloride salt in the organic phase composition is greater than 5, preferably greater than 10 and more preferably greater than 15.

According to another embodiment the chloride salt concentration in the organic phase composition is in a range between 0.01% wt and 5% wt, preferably between 0.02% wt and 4% wt and more preferably between 0.03% wt and 3% wt.

According to an embodiment, the first extractant is formed from the organic phase composition. Thus, according to an embodiment, the method comprises a step of removing S2 from the organic phase composition, whereupon the first extractant is formed. Any method of removing S2 is suitable. According to a preferred embodiment, S2 is removed by distillation. According to alternative embodiments, S2 is fully removed or only partially removed. According to an embodiment, both S2 and water are removed from the organic phase composition in order to form the first extractant.

According to an embodiment, upon said removal of S2, a heavy aqueous phase is formed and said heavy phase is separated from said formed first extractant. According to an embodiment, the HCl/water ratio in the heavy phase is smaller than that ratio in the HCl-depleted aqueous feed. According to another embodiment the HCl/chloride salt ratio in the heavy phase is smaller than that ratio in the HCl-depleted aqueous feed.

As further explained in the literature, delta-P and delta-H could be assigned to single components as well as to their mixtures. In most cases, the values for the mixtures could be calculated from those of the single components and their proportions in the mixtures. According to a preferred embodiment, the second extractant is more hydrophilic than the first extractant. According to an embodiment, S1 is the main or sole component of the first extractant. According to another embodiment, a mixture of S1 and S2 forms the main or only components of the second extractant. S2 is more hydrophilic (has higher polarity and/or higher capacity of forming hydrogen bonds) than S1. Thus, preferably, the second extractant is more hydrophilic than the first extractant. According to an embodiment, the delta-P of the second extractant is greater than the delta-P of said first extractant by at least 0.2 MPa^{1/2}; preferably at least 0.4 MPa^{1/2} and more preferably at least 0.6 MPa^{1/2}. According to another embodiment, the delta-H of the second extractant is greater than delta-H of said first extractant by at least 0.2 MPa^{1/2}, preferably at least 0.4 MPa^{1/2} and more preferably at least 0.6 MPa^{1/2}. According to still another embodiment, both the delta-P and the delta-H of the second extractant are greater than those of the first extractant by at least 0.2 MPa^{1/2}, preferably at least 0.4 MPa^{1/2} and more preferably at least 0.6 MPa^{1/2}.

According to an embodiment both extractants comprise S1 and S2 and the S2/S1 ratio in the second extractant is greater than the S2/S1 ratio in the first extractant by at least 10%, preferably by at least 30%, more preferably that ratio in the second extractant is at least 2 times greater than that in the first and most preferably at least 5 times greater.

According to a preferred embodiment of the invention, the first extractant is more selective with regards to HCl extraction than the second extractant. Selectivity to acid over water (S_{A/W}) can be determined by equilibrating an aqueous HCl solution with an extractant and analyzing the concentrations of the acid and the water in the equilibrated phases. In that case, the selectivity is:

S_{A/W}=(C_{A}/C_{W})org/(C_{A}/C_{W})aq

wherein (C_{A}/C_{W})aq is the ratio between acid concentration and water concentration in the aqueous phase and (C_{A}/C_{W})org is that ratio in the organic phase. According to an embodiment, when determined at C_{A} aqueous concentration of 1 molar, S_{A/W} of the first extractant is greater than that of the second extractant by at least 10%, preferably at least 30% and more preferably at least 50%.

Similarly, selectivity to acid over a chloride salt (S_{A/S}) can be determined by equilibrating a chloride salt-comprising aqueous HCl solution with an extractant and analyzing the concentrations of the acid and the chloride salt in the equilibrated phases. In that case, the selectivity is:

S_{A/C}=(C_{A}/C_{S})org/(C_{A}/C_{S})aq

According to an embodiment, when determined at C_{A} aqueous concentration of 1 molar and C_{S} aqueous concentration of 1 molar, S_{A/S} of the first extractant is greater than that of the second extractant by at least 10%, preferably at least 30% and more preferably at least 50%.

According to an embodiment, the HCl/water ratio in the first extract is greater than that ratio in the organic phase composition of step (iii) by at least 10%, preferably at least 30% and more preferably at least 50%.

According to another embodiment, the HCl/chloride salt ratio in the first extract is greater than that ratio in the organic phase composition of step (iii) by at least 10%, preferably at least 30% and more preferably at least 50%.

The distribution coefficient of HCl extraction (D_{A}) can be determined by equilibrating an aqueous HCl solution with an extractant and analyzing the concentrations of the acid in the equilibrated phases. In that case, the distribution coefficient is:

D_{A}=Corg/Caq

wherein Corg and Caq are acid concentrations in the organic and aqueous phases, respectively. According to an embodiment, when determined at Caq of 1 molar, D_{A} of the second extractant is greater than that of the first extractant by at least 10%, preferably by at least 30% and more preferably by at least 50%.

According to an embodiment, the method for the separation of HCl from a chloride salt uses a system comprising two extraction units and a distillation unit, as shown in FIG. 1. Referring to said figure, the aqueous feed is extracted first in Solvent Extraction #1 to form the HCl-depleted aqueous feed, which is then extracted in Solvent Extraction #2 to form the further HCl-depleted aqueous feed. The second extractant extracts HCl from the HCl-depleted aqueous feed in Solvent Extraction #2 to form the organic phase composition. The organic composition is treated in Distillation to remove at least part of the S2 therein and to form the first extractant. The first extractant is then used to extract HCl from the aqueous feed in Solvent Extraction #1 and to form the HCl-carrying first extract.

The method of the present invention comprises a step of HCl recovery from the HCl-carrying first extract. According to an embodiment, recovering comprises at least one of HCl distillation from the first extract. According to an embodiment, water and optionally S1 are co-distilled with HCl. According to an embodiment, HCl, S1 and water are distilled and the vapors are condensed to form two phases, a light phase and a heavy phase. The light phase comprises mainly S1 and can be used to reform the first extractant, the second extractant or both. The heavy phase is an aqueous solution of HCl. Alternatively, and or in addition, HCl recovery from the first extract comprises back-extraction with water or with an aqueous solution.

Recovery of the acid from the HCl-carrying first extract regenerates S1 to form a regenerated S1. Said regenerated S1 is used, according to an embodiment, for forming said second extractant. According to an embodiment, forming said second extractant comprises combining the regenerated S1 with S2. Preferably combining is with S2 separated from the organic phase composition during the formation of the first extractant.

According to still another embodiment, the provided aqueous feed comprises an impurity, the impurity/chloride salt ratio in said feed is R1, the impurity/chloride salt ratio in the further HCl-depleted aqueous feed is R2 and the R1/R2 ratio is greater than 1.5. According to an embodiment, said impurity is another acid, e.g. phosphoric acid. According to another embodiment, said impurity is another salt, e.g. iron chloride.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

### EXAMPLES

1.3 gr 20% HCl solution, 1.42 gr water, 0.15 gr FeCl₃*6H₂O, and 1.3 gr hexanol or 1.3 gr butanol were introduced into a vial. The closed vial was shaken at 25° C. for 2 min. The phases were then separated and analyzed for HCl concentrations (by titration) and Fe (with ammonium thio-cyanide). The results are presented in Table 1.

TABLE 1

| | Light phase | | heavy phase | | HCl | Fe | |
|---|---|---|---|---|---|---|---|
| | composition | | composition | | distri- | distri- | |
| | HCl | Fe | HCl | Fe | bution | bution | select- |
| solvent | Wt % | Wt % | Wt % | Wt % | coefficient | coefficient | ivity |
| hexanol | 2.28 | 0.088 | 11.5 | 1.18 | 0.20 | 0.075 | 2.67 |
| butanol | 4.88 | 0.185 | 10.5 | 1.01 | 0.46 | 0.183 | 2.52 |

These results demonstrate selective extraction of HCl from the chloride salt when a hydrophobic solvent such as hexanol is used. The results also show a selective extraction of HCL form the chloride salt when butanol is used.

It will be understood by those skilled in the art that various changes in form and details may be made herein without departing from the spirit and scope of the invention as set forth in the appended claims. Those skilled in the art will recognize, or be able to ascertain using no more than routine experimentation, many equivalents to the specific embodiments of the invention described herein. Such equivalents are intended to be encompassed in the scope of the claims. In the claims articles such as “a,”, “an” and “the” mean one or more than one unless indicated to the contrary or otherwise evident from the context. Claims or descriptions that include “or” or “and/or” between members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides, in various embodiments, all variations, combinations, and permutations in which one or more limitations, elements, clauses, descriptive terms, etc., from one or more of the listed claims is introduced into another claim dependent on the same base claim unless otherwise indicated or unless it would be evident to one of ordinary skill in the art that a contradiction or inconsistency would arise. Where elements are presented as lists, e.g., in Markush group format or the like, it is to be understood that each subgroup of the elements is also disclosed, and any element(s) can be removed from the group. It should it be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in haec verba herein. Certain claims are presented in dependent form for the sake of convenience, but Applicant reserves the right to rewrite any dependent claim in independent format to include the elements or limitations of the independent claim and any other claim(s) on which such claim depends, and such rewritten claim is to be considered equivalent in all respects to the dependent claim in whatever form it is in (either amended or unamended) prior to being rewritten in independent format.

1. An organic phase composition comprising
(a) a first solvent (S1) characterized by water solubility of less than 10% and by at least one of (a1) having a polarity related component of Hoy's cohesion parameter (delta-P) between 5 and 10 MPa½ and (b1) having a Hydrogen bonding related component of Hoy's cohesion parameter (delta-H) between 5 and 20 MPa½;
(b) a second solvent (S2) characterized by water solubility of at least 30% and by at least one of (a2) having a delta-P greater than 8 MPa/2 and (b2) having a delta-H greater than 12 MPa/2;
(c) water
(d) HCI, and
(e) a chloride salt.

2. The composition according to claim 1, wherein S2 is selected from the group consisting of C1-C4 mono- and or poly-alcohols, aldehydes and ketones.

3. (canceled)

4. The composition according to claim 1, wherein said chloride salt is selected from the group consisting of chlorides of calcium and of heavy metals.

5. The composition according to claim 1, wherein the S1/S2 weight/weight ratio is in the range between 10 and 0.5.

6. The composition according to claim 1, wherein the HCI/water weight/weight ratio is greater than 0.15.

7. (canceled)

8. The composition according to claim 1, wherein the chloride salt concentration is in a range between 0.01% wt and 5% wt.

9.-10. (canceled)

11. A method for the separation of HCI from a chloride salt comprising
(i) providing an aqueous feed solution comprising HCI and a chloride salt;
(ii) bringing said aqueous feed solution into contact with a first extractant comprising a first solvent S1 characterized by water solubility of less than 10% and by at least one of (a1) having a delta-P between 5 and 10 MPa½ and (b1) having a delta-H between 5 and 20 MPa½, whereupon HCI selectively transfers to said first extractant to form an HCI-carrying first extract and an HCI-depleted aqueous feed;
(iii) bringing said HCI-depleted aqueous feed solution into contact with a second extractant comprising S1 and a second solvent S2 characterized by water solubility of at least 30% and by at least one of (a2) having a delta-P greater than 8 MPa½ and (b2) having a delta-H greater than 12 MPa½, whereupon HCI selectively transfers to said second extractant to form an organic composition according to claim 1 and claim 10 and a further HCI-depleted aqueous feed; and
(iv) recovering HCI from said first extract.

12. The method according to claim 7, wherein said aqueous feed is a product of leaching a mineral with HCI.

13. The method according to claim 11, wherein said mineral is rich in titanium.

14.-16. (canceled)

17. The method according to claim 7, wherein said delta-P of said second extractant is greater than said delta-P of said first extractant by at least 0.2 MPa½.

18. The method according to claim 7, wherein said delta-H of said second extractant is greater than said delta-H of said second extractant by at least 0.2 MPa½.

19.-20. (canceled)

21. The method according to claim 7, further comprising removing S2 from the organic composition formed in step (iii), to generate said first extractant

22. and a heavy aqueous phase and separating said heavy phase from said first extractant.

23. The method according to claim 12, wherein the HCI/water weight/weight ratio in said heavy phase is smaller than that ratio in the HCI-depleted aqueous feed.

24. The method according to claim 12, wherein the HCI/salt weight/weight ratio in said heavy phase is smaller than that ratio in the HCI-depleted aqueous feed.

25. The method according to claim 7, wherein the HCI/water weight/weight ratio in said first extract is greater than that ratio in the organic composition of step (iii) by at least 10%.

26. The method according to claim 7, wherein the HCI/water weight/weight ratio in said first extract is greater than that ratio in the aqueous feed by at least 10%.

27. The method according to claim 7, wherein the HCI/salt weight/weight ratio in said first extract is greater than that ratio in the organic composition of step (iii) by at least 10%.

28. (canceled)

29. The method according to claim 7, wherein the HCI/salt ratio in said further depleted aqueous feed is smaller than 0.05.

30. The method according to claim 7, wherein said provided aqueous feed comprises an impurity, wherein the impurity/salt ratio in said feed is R1, wherein the impurity/salt ratio in said further depleted aqueous feed is R2 and wherein R1/R2 is greater than 1.5.

31. (canceled)

32. The method according to claim 30, wherein said impurity is another salt.
